(19) United States
(12) Patent Application Publication
(10) Pub. No.: US 2025/0046088 A1
(43) Pub. Date: Feb. 6, 2025

(54) SURVEILLANCE CAMERA IMAGE ANALYSIS SYSTEM

(71) Applicant: Mitsubishi Electric Corporation, Chiyoda-ku, Tokyo (JP)

(72) Inventor: Shun CHIKAMORI, Tokyo (JP)

(21) Appl. No.: 18/719,096

(22) PCT Filed: Jan. 11, 2022
(86) PCT No.: PCT/JP2022/000448

§ 371 Date: Jun. 12, 2024

(51) Int. Cl. G06V 20/52; G06T 7/12; G06V 10/764

(52) U.S. Cl. CPC G06V 20/52; G06T 7/12; G06V 10/764

(57) ABSTRACT

A surveillance camera image analysis system according to the presently disclosed technology includes a first surveillance camera, and the first surveillance camera includes a deep learning inference processing unit having artificial intelligence capable of learning, in which the artificial intelligence learns using supervised learning data, and the supervised learning data is divided in accordance with one or more image shooting angles and one or more object distances.

### TECHNICAL FIELD

The presently disclosed technology relates to a surveillance camera image analysis system.

### BACKGROUND ART

Surveillance cameras are widely used in the field of security through the application of an image analysis technology to the surveillance cameras. Systems for analyzing a video or an image using surveillance cameras are referred to as surveillance camera image analysis systems.

Image analysis technologies include an image analysis technology of providing supervised learning data, and performing learning to generate discrimination rules. For example, Patent Literature 1 discloses a technology of automatically generating supervised learning data in an image analysis device including a learning function.

### CITATION LIST

### Patent Literature

Patent Literature 1: Japanese Unexamined Patent Application Publication No. H07-21367

### SUMMARY OF INVENTION

### Technical Problem

Although, for image analysis devices including a learning function, the more supervised learning data there are, the more the inference accuracy is improved, there is a limit to the preparation of many pieces of supervised learning data. In the field of image analysis devices, there is a demand for an improvement in the inference accuracy even though the number of pieces of supervised learning data is the same.

The presently disclosed technology is made in consideration of the above-mentioned problem, and it is an object of the presently disclosed technology to provide a surveillance camera image analysis system which can raise the inference accuracy higher than that in conventional systems even though learning is performed on the basis of the same supervised learning data as those of the conventional systems.

### Solution to Problem

A surveillance camera image analysis system according to the presently disclosed technology includes a first surveillance camera, and the first surveillance camera includes a deep learning inference processing unit having artificial intelligence capable of learning, in which the artificial intelligence learns using supervised learning data, and the supervised learning data is divided in accordance with one or more image shooting angles and one or more object distances.

### Advantageous Effects of Invention

Because the surveillance camera image analysis system according to the presently disclosed technology has the above-mentioned configuration, the surveillance camera image analysis system can achieve a percentage of correct answers which is higher compared with those achieved by systems which have learned using supervised learning data which is not divided in accordance with image shooting angles and object distances.

### BRIEF DESCRIPTION OF DRAWINGS

FIG. 1 is a schematic view showing the learning processing of a deep learning inference processing unit of a first surveillance camera according to the presently disclosed technology:

FIG. 2 is a block diagram showing functional blocks of a surveillance camera image analysis system according to Embodiment 1;

FIG. 3 is a flowchart showing the processing of the surveillance camera image analysis system according to Embodiment 1;

FIG. 4 is a flowchart showing a second example of the processing of the surveillance camera image analysis system according to Embodiment 1;

FIG. 5 is a block diagram showing functional blocks of a surveillance camera image analysis system according to Embodiment 2;

FIG. 6 is a flowchart showing the processing of the surveillance camera image analysis system according to Embodiment 2;

FIG. 7 is a block diagram showing functional blocks of a surveillance camera image analysis system according to Embodiment 3; and

FIG. 8 is a view showing a hardware configuration for implementing the functions of the surveillance camera image analysis system according to the presently disclosed technology.

### DESCRIPTION OF EMBODIMENTS

### Embodiment 1

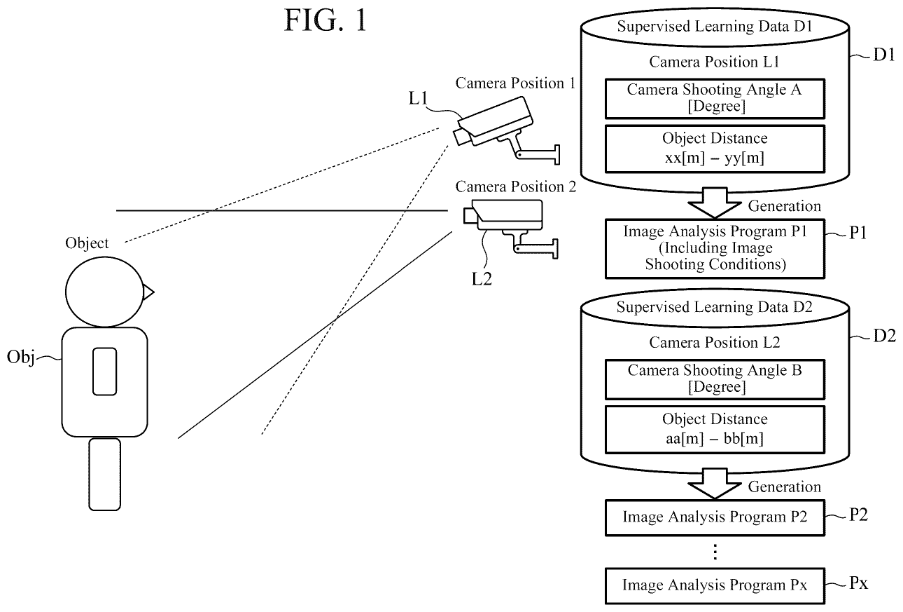

FIG. 1 is a schematic view showing the learning processing of a deep learning inference processing unit 1130 mounted in a first surveillance camera 1000 according to the presently disclosed technology. The first surveillance camera 1000 is a component of a surveillance camera image analysis system according to the presently disclosed technology. The details of components of the surveillance camera image analysis system will be clear in a later explanation.

The surveillance camera image analysis system according to the presently disclosed technology includes the first surveillance camera 1000. More concretely, the surveillance camera image analysis system according to the presently disclosed technology performs classification, identification, evaluation, tracking, action prediction, or the like on an image shot by the first surveillance camera 1000. Classification, identification, evaluation, tracking, or action prediction is implemented by the deep learning inference processing unit 1130 having artificial intelligence (AI) capable of learning. The deep learning inference processing unit 1130 having artificial intelligence may perform semantic segmentation which identifies what is seen in a moving image on a per pixel basis. A learning problem to be solved by the artificial intelligence of the deep learning inference processing unit 1130 in the presently disclosed technology is supervised learning.

The artificial intelligence of the deep learning inference processing unit 1130 may be a neural network, such as a deep neural network (DNN), a convolutional neural network (CNN), or a recurrent neural network (RNN). Further, in the case where the deep learning inference processing unit 1130 performs semantic segmentation, although it is desirable that the artificial intelligence is a fully convolutional network (FCN) which is a type of CNN, the artificial intelligence may be another convolutional network, such as SegNet, U-Net, PSPNet, or DeepLab.

The artificial intelligence of the deep learning inference processing unit 1130 may be implemented by another mathematical model capable of learning, instead of a neural network.

Although an object Obj shown in FIG. 1 has a human shape, the object Obj is not limited to a human. The object Obj may be a weapon such as a kitchen knife, or a vehicle such as a car.

### <Learning Phase>

Each of image analysis programs P1, P2, . . . , and Px shown in FIG. 1 is the artificial intelligence of the deep learning inference processing unit 1130. Although the image analysis programs P1, P2, . . . , and Px may have the same parameters and the same program structure in the initial state, each of the image analysis programs performs learning using a different piece of supervised learning data. The learning may be deep learning or machine learning. For example, the image analysis program P1 performs learning using a piece of supervised learning data D1.

Pieces of supervised learning data are divided in accordance with image shooting angles and object distances. More concretely, each of the pieces of the supervised learning data D1, D2, . . . , and Dx includes moving images shot by a camera placed at a different camera position. For example, the piece of supervised learning data D1 includes moving images shot by a camera at a camera position L1. Elements which determine the camera position L1 include a camera shooting angle and the distance from the camera to the object Obj (referred to as the “object distance” hereinafter). For example, as to the camera position L1, the camera shooting angle is A [degree] and the object distance ranges from xx [m] to yy [m]. Similarly, as to a camera position L2, the camera shooting angle is B [degree] and the object distance ranges from aa [m] to bb [m]. In this way, the object distance may be expressed by a range.

The camera shooting angle is an angle at which the camera is hold. As the angle in a typical camera, there are three types of angles: a high angle, horizontal, a low angle. For example, while the types of rotation showing the posture of a vehicle such as an airplane include a roll, a pitch, and a yaw, the camera shooting angle in the presently disclosed technology is associated with a pitch in the case of replacing the camera with a vehicle. More specifically, the camera shooting angle in the presently disclosed technology shows whether the camera is facing downwards (high angle), horizontally, or upwards (low angle).

Further, the pieces of supervised learning data D1, D2, . . . , and Dx may be divided in accordance with image shooting conditions, other than the camera positions. The image shooting conditions include, for example, the magnifications, the focal lengths, and the angles of view of the cameras, or the weather.

Further, in further detail, each of the pieces of supervised learning data D1, D2, . . . , and Dx is a learning data set including a pair of a moving image shot by a camera and a correct answer label. For example, in the case where the problem to be solved by the artificial intelligence of the deep learning inference processing unit 1130 is semantic segmentation, the correct answer label is a mask image in which the silhouette of a target to be identified is masked in a corresponding color. The corresponding color is defined previously in such a way that the corresponding color for persons is blue, the corresponding color for weapons such as a kitchen knife is red, and the corresponding color for vehicles such as a car is green, and may be determined by the producer of the learning data set.

Moving images shot by the cameras, out of the learning data sets, are input images inputted to the image analysis programs P1, P2, . . . , and Px, and mask images showing correct answer labels, out of the learning data sets, are output images outputted by the image analysis programs P1, P2, . . . , and Px. More specifically, each of the learning data sets is a pair of an input to the artificial intelligence, and an output of a correct answer corresponding to the input.

Because the artificial intelligence of the deep learning inference processing unit 1130 includes the different image analysis programs P1, P2, . . . , and Px for the respective camera positions L1, L2, . . . , and Lx, as mentioned above, the artificial intelligence can achieve a percentage of correct answers which is higher compared with that achieved by a surveillance camera image analysis system including only one image analysis program.

### <Inference Phase>

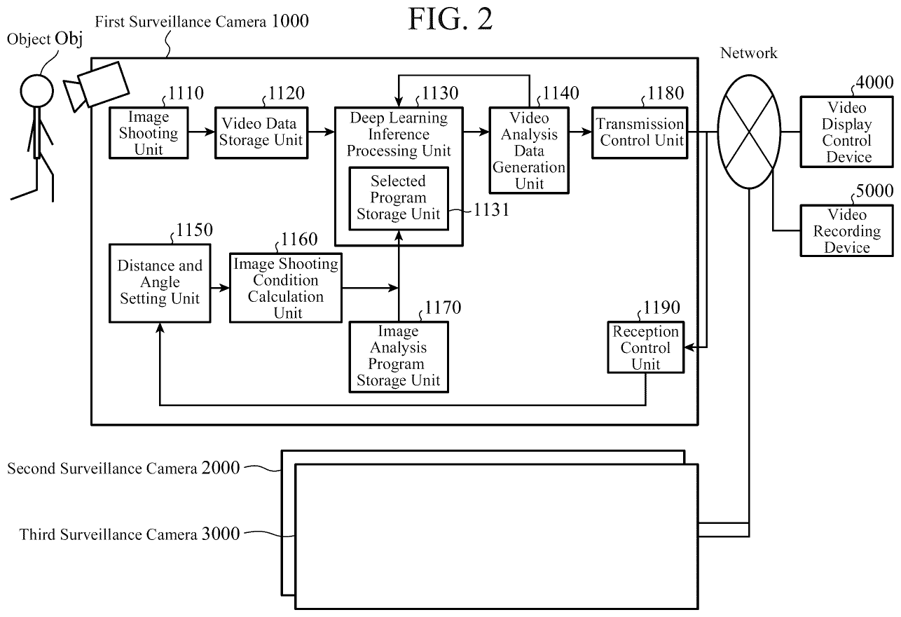

FIG. 2 is a block diagram showing the functional blocks of the surveillance camera image analysis system according to Embodiment 1. As shown in FIG. 2, the surveillance camera image analysis system according to Embodiment 1 includes one or more surveillance cameras including at least the first surveillance camera 1000, a video display control device 4000, and a video recording device 5000. The first surveillance camera 1000, the video display control device 4000, and the video recording device 5000 are in a state in which they can communicate with one another via a network. The video display control device 4000 controls the one or more surveillance cameras including at least the first surveillance camera 1000. The video recording device 5000 records a video shot by the one or more surveillance cameras including at least the first surveillance camera 1000.

As shown in FIG. 2, the first surveillance camera 1000 includes an image shooting unit 1110, a video data storage unit 1120, the deep learning inference processing unit 1130, a video analysis data generation unit 1140, a distance and angle setting unit 1150, an image shooting condition calculation unit 1160, an image analysis program storage unit 1170, a transmission control unit 1180, and a reception control unit 1190.

In the case where the surveillance camera image analysis system has a second surveillance camera 2000, the configuration of the second surveillance camera 2000 may be the same as that of the first surveillance camera 1000. Further, also in the case where the surveillance camera image analysis system has a third surveillance camera 3000, the configuration of the third surveillance camera 3000 may be the same as that of the first surveillance camera 1000.

The image shooting unit 1110 of the first surveillance camera 1000 is a functional block which shoots a video within the angle of view of the first surveillance camera 1000. The video shot by the image shooting unit 1110 is outputted to the video data storage unit 1120.

The video data storage unit 1120 of the first surveillance camera 1000 is a functional block which temporarily stores data which includes the video transmitted from the image shooting unit 1110 (referred to as “video data” hereinafter).

The first surveillance camera 1000 includes the deep learning inference processing unit 1130 provided with the artificial intelligence which has learned.

The deep learning inference processing unit 1130 of the first surveillance camera 1000 includes the artificial intelligence, as mentioned above. Further, the deep learning inference processing unit 1130 includes a selected program storage unit 1131. In the inference phase, in the deep learning inference processing unit 1130, at least one of the image analysis programs P1, P2, . . . , and Px which is the artificial intelligence which has learned is stored in the selected program storage unit 1131.

The deep learning inference processing unit 1130 of the first surveillance camera 1000 performs inference on the video data temporarily stored in the video data storage unit 1120 using the artificial intelligence which has learned. Concretely, the inference is classification, identification, evaluation, tracking, or action prediction. Further, the inference may be implemented by semantic segmentation. Concretely, the artificial intelligence which has learned is at least one of the image analysis programs P1, P2, . . . , and Px, and the inference performed by the artificial intelligence which has learned is implemented by performing an image analysis on the video data temporarily stored.

The reception control unit 1190 of the first surveillance camera 1000 receives control information from the video display control device 4000 via the network. Here, the control information is about the first surveillance camera 1000 controlled by the video display control device 4000, and, concretely, includes the camera shooting angle and the object distance of the first surveillance camera 1000. The control information from the video display control device 4000 corresponds to the camera position and the image shooting conditions in the learning phase.

The camera shooting angle may be simply referred to as the shooting angle.

The distance and angle setting unit 1150 of the first surveillance camera 1000 determines the shooting angle and the object distance at an image shooting time in the inference phase (simply referred to as the “image shooting time” hereinafter) from the control information received by the reception control unit 1190.

The image shooting condition calculation unit 1160 of the first surveillance camera 1000 determines the image shooting conditions at the image shooting time from the control information received by the reception control unit 1190. The shooting angle and the object distance which are determined in the distance and angle setting unit 1150 are taken into consideration at the time of determining the image shooting conditions.

Although an arrow directly connected from the functional block of the reception control unit 1190 to the functional block of the image shooting condition calculation unit 1160 is not shown in the block diagram shown in FIG. 2, this is a result of simply taking the viewability of FIG. 2 into consideration. Further, although an arrow extending from the functional block of the image shooting condition calculation unit 1160 in the block diagram shown in FIG. 2 points to not a functional block, but an arrow extending from the image analysis program storage unit 1170, this is also a result of simply taking the viewability into consideration.

The image analysis program storage unit 1170 of the first surveillance camera 1000 includes multiple pieces of artificial intelligence which have learned. Concretely, the multiple pieces of artificial intelligence which have learned are the image analysis programs P1, P2, . . . , and Px which have learned separately for the respective camera positions L1, L2, . . . , and Lx.

As mentioned above, the image analysis programs P1, P2, . . . , and Px may have the same parameters and the same program structure in the initial state of the learning phase, and each of the image analysis programs has learned using a different piece of supervised learning data. In the case where the image analysis programs P1, P2, . . . , and Px have the same program structure, the difference between the image analysis programs P1, P2, . . . , and Px is only the difference between the parameters adjusted along with the learning. Therefore, the image analysis program storage unit 1170 may be configured in such a way that only the adjusted parameters of each of the image analysis programs P1, P2, . . . , and Px are stored. The parameters of the image analysis programs P1, P2, . . . , and Px are, for example, weights and biases in the case where the programs are based on a neural network.

The deep learning inference processing unit 1130 of the first surveillance camera 1000 selects an image analysis program whose camera position L1, L2, . . . , or Lx is the closest to the one at the image shooting time, out of the image analysis programs P1, P2, . . . , and Px which have learned and which are stored in the image analysis program storage unit 1170, on the basis of the shooting angle and the object distance at the image shooting time which are determined by the distance and angle setting unit 1150, and the image shooting conditions at the image shooting time which are determined by the image shooting condition calculation unit 1160. For example, when the camera position L1 is selected as the one which is the closest to the camera position at the image shooting time, the image analysis program P1 which has learned is selected. The deep learning inference processing unit 1130 stores the selected image analysis program P1 which has learned in the selected program storage unit 1131.

In the case where what is stored in the image analysis program storage unit 1170 is the adjusted parameters of each of the image analysis programs P1, P2, . . . , and Px, the deep learning inference processing unit 1130 stores the adjusted parameters corresponding to the selected image analysis program in the selected program storage unit 1131 in such a way as to enable the selected image analysis program to be used.

As mentioned above, some arrows connecting between functional blocks in FIG. 2 may be omitted in consideration of the viewability of FIG. 2. The figures shown in this specification, including FIG. 2, do not perfectly show all the operations of the functional blocks, but visually provide a supplementary explanation for the specification.

The video analysis data generation unit 1140 of the first surveillance camera 1000 is a functional block which superimposes the video of the inference result which is the output of the deep learning inference processing unit 1130 onto the input video inputted to the deep learning inference processing unit 1130.

For example, it is assumed that the image analysis program P1 which has learned and which is stored in the selected program storage unit 1131 has learned in such a way as to perform semantic segmentation to mask only persons in blue. In this case, the video analysis data generation unit 1140 superimposes a masked video including blue-masked objects, which is the inference result, onto the input video. Here, the data which includes the input video is referred to as the “video data”, and the data which includes the superimposed video is referred to as the “video analysis data.”

The artificial intelligence which has learned in the deep learning inference processing unit 1130 may have been made to learn in such a way as to also serve as the function of the video analysis data generation unit 1140 and output the superimposed video analysis data.

The transmission control unit 1180 of the first surveillance camera 1000 transmits the video data and the video analysis data to the network. The video data and the video analysis data which are transmitted to the network are stored in, for example, the video recording device 5000.

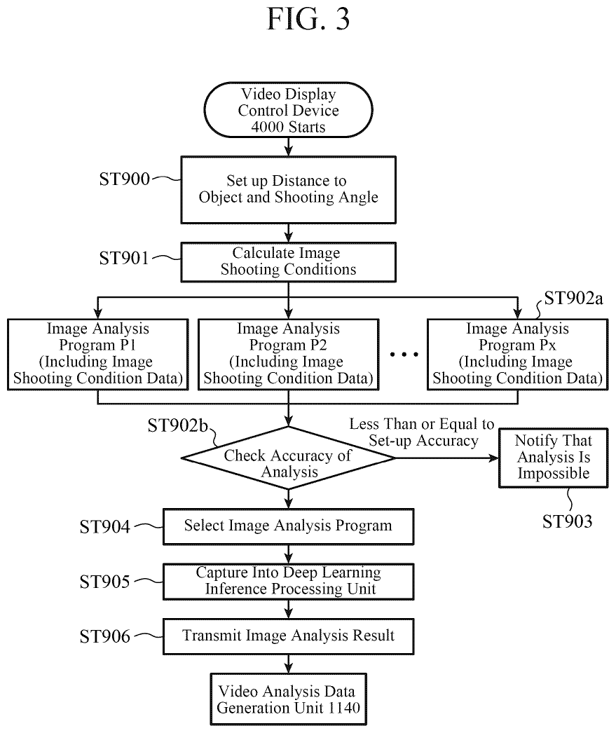

FIG. 3 is a flowchart showing the processing of the surveillance camera image analysis system according to Embodiment 1. As shown in FIG. 3, the processing of the surveillance camera image analysis system includes processing steps from ST900 to ST906.

Step ST900 is a process in which the video display control device 4000 assists a user of the surveillance camera image analysis system to set up the shooting angle and the object distance of the first surveillance camera 1000.

The video display control device 4000 according to Embodiment 1 includes a not-illustrated display, to display the various parameters of the first surveillance camera 1000 for the user of the surveillance camera image analysis system. The video display control device 4000 according to Embodiment 1 also includes a keyboard, a mouse, etc. which are not illustrated, and is programmed to enable the user to input the shooting angle and the object distance of the first surveillance camera 1000 which the user desires to set up.

The video display control device 4000 controls the first surveillance camera 1000 via the network. Concretely, the video display control device 4000 writes the setting values of the shooting angle and the object distance into the distance and angle setting unit 1150 of the first surveillance camera 1000 via the network. The first surveillance camera 1000 in which the setting values are written into the distance and angle setting unit 1150 is controlled as a result in such a way that the current shooting angle and the current object distance are equal to the setting values.

Further, even in the case where the shooting angle and the object distance of the first surveillance camera 1000 are fixed and the first surveillance camera cannot be controlled from the outside, the surveillance camera image analysis system according to the presently disclosed technology can be made to operate. In this case, the user of the surveillance camera image analysis system may directly go to the site where the first surveillance camera 1000 is installed, and may measure the shooting angle and the object distance using a not-illustrated measurement tool. In this case, the video display control device 4000 is programmed to enable the user to input the shooting angle and the object distance of the first surveillance camera 1000 which the user has measured directly.

Step ST901 is a process which the video display control device 4000 performs. In step ST901, the video display control device 4000 communicates with the first surveillance camera 1000 via the network, and calculates the image shooting conditions of the first surveillance camera 1000. As mentioned above, the image shooting conditions include, for example, the magnification, the focal length, the angle of view of the camera, or the weather. In the calculation of the image shooting conditions, the shooting angle and the object distance of the first surveillance camera 1000 which are set up are taken into consideration.

Step ST902 is divided into step ST902a and step ST902b.

Step ST902a is a process which the deep learning inference processing unit 1130 performs. In step ST902a, the deep learning inference processing unit 1130 selects an image analysis program whose camera position L1, L2, . . . , or Lx is the closest to the one at the image shooting time, out of the image analysis programs P1, P2, . . . , and Px which have learned and which are stored in the image analysis program storage unit 1170, on the basis of the shooting angle and the object distance at the image shooting time which are determined by the distance and angle setting unit 1150, and the image shooting conditions at the image shooting time which are determined by the image shooting condition calculation unit 1160. The program selected here is referred to as the “selected program.”

Step ST902b is a process which the deep learning inference processing unit 1130 performs. In step ST902b, the deep learning inference processing unit 1130 determines whether or not the accuracy of the analysis is sufficient on the basis of the image shooting conditions calculated in step ST901, and the camera position of the selected program selected in step ST902a.

Here, although the accuracy of the analysis typically means the percentage of correct answers of the image analysis program, it is understood empirically that, in the image analysis, the accuracy of the analysis has a close relation to the shooting angle and the object distance. Then, in the presently disclosed technology, the accuracy of the analysis is determined on the basis of the shooting angle and the object distance.

As mentioned above, the elements which determine the camera position L1 include the camera shooting angle and the object distance, for each of which it is assumed that a range is provided. When the image shooting conditions calculated in step ST901 are not included in the camera position of the selected program selected in step ST902a, the processing proceeds to step ST903. When the image shooting conditions calculated in step ST901 are included in the camera position of the selected program selected in step ST902a, the processing proceeds to step ST904.

For example, it is assumed that there are two image analysis programs in all. It is assumed that the image analysis program P1 has been made to learn using images shot by a surveillance camera whose shooting angle ranges from 0 [degree] to 60 [degree], and whose object distance ranges from 2 [m] to 6 [m]. Further, it is assumed that the image analysis program P2 has been made to learn using images shot by a surveillance camera whose shooting angle ranges from 0 [degree] to 30 [degree], and whose object distance ranges from 10 [m] to 15 [m]. It is assumed that the current image shooting conditions of the first surveillance camera 1000 are the shooting angle of 85 [degree] and the object distance of 1 [m]. Then, because the image shooting conditions determined in step ST901 are not included in the camera position of the selected program selected in step ST902a, the processing proceeds to step ST903.

Step ST903 is a process which the deep learning inference processing unit 1130 performs. In step ST903, the deep learning inference processing unit 1130 generates a notification showing that “the accuracy of the analysis drops” or that “the analysis is impossible”, and outputs the notification to the video display control device 4000 via the transmission control unit 1180 and the network.

Step ST904 is a process which the deep learning inference processing unit 1130 performs. In step ST904, the deep learning inference processing unit 1130 selects, as the selected program, an image analysis program whose camera position range includes the current image shooting conditions.

Step ST905 is a process which the deep learning inference processing unit 1130 performs. In step ST905, the deep learning inference processing unit 1130 performs inference on the video data temporarily stored in the video data storage unit 1120 using the selected program stored in the selected program storage unit 1131.

Step ST906 is a process which the deep learning inference processing unit 1130 performs. In step ST906, the deep learning inference processing unit 1130 transmits an image analysis result which is a result of the inference to the video analysis data generation unit 1140.

By the way, the type of the image analysis performed by the surveillance camera image analysis system according to the presently disclosed technology is not limited to a single one. For example, in the deep learning inference processing unit 1130 of the first surveillance camera 1000 according to Embodiment 1, the artificial intelligence which has learned may perform semantic segmentation and further perform a category prediction (or simply referred to as a “classification”) to infer an attribute of a person who is an object Obj, like the gender or the age group of the person.

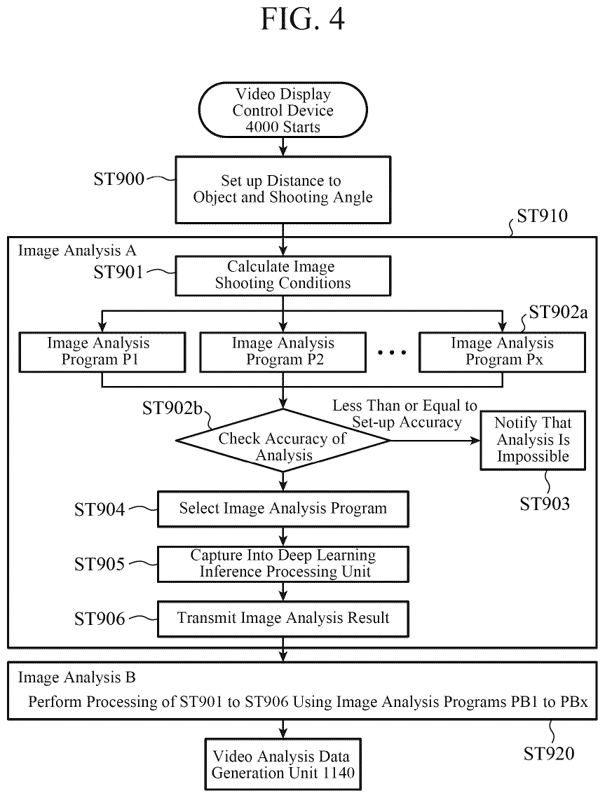

FIG. 4 is a flowchart showing a second example of the processing of the surveillance camera image analysis system according to Embodiment 1. The second example of the processing is a case in which there are two types of image analyses which the surveillance camera image analysis system according to Embodiment 1 performs.

In FIG. 4, an image analysis A (processing block shown in ST910 of FIG. 4) is, for example, semantic segmentation.

In FIG. 4, an image analysis B (processing block shown in ST920 of FIG. 4) is, for example, a category prediction.

As shown in FIG. 4, the surveillance camera image analysis system according to Embodiment 1 may perform the processes associated with the image analysis A and the processes associated with the image analysis B not in parallel, but in series, i.e., not at the same time, but at different times.

In this way, in the first surveillance camera 1000 according to Embodiment 1, two or more types of programs, for example, a program for semantic segmentation and a program for category prediction may be stored in the image analysis program storage unit 1170 and in the selected program storage unit 1131.

As mentioned above, because the surveillance camera image analysis system according to Embodiment 1, particularly the first surveillance camera 1000 includes the image analysis programs P1, P2, . . . , and Px separately for the respective camera positions L1, L2, . . . , and Lx, as mentioned above, the surveillance camera image analysis system can achieve a percentage of correct answers which is higher compared with that achieved by a surveillance camera image analysis system including only one image analysis program.

When the accuracy of the analysis cannot be maintained by any one of the image analysis program P1, P2, . . . , and Px currently prepared, the surveillance camera image analysis system according to Embodiment 1 can notify the user in advance that it is impossible to perform an analysis or that the accuracy of the analysis drops. As a result, the user can recognize that there is an unanalyzable event, at the time of installing surveillance cameras. Further, the user can re-evaluate the installation locations without performing an operation of changing the installation locations over and over again in order to raise the accuracy of the analysis, and can perform a determination on the installation of surveillance cameras at locations where no problems arise even though the accuracy of the image analysis drops.

The surveillance camera image analysis system according to Embodiment 1 determines the accuracy of the analysis on the basis of the shooting angle and the object distance. The video display control device 4000 according to Embodiment 1 also includes a keyboard, a mouse, etc. which are not illustrated, and is programmed in such a way as to enable the user to input the shooting angle and the object distance of the first surveillance camera 1000 which the user desires to set up. With this configuration, the user can use the image analysis programs while being aware of the shooting angle and the object distance.

### Embodiment 2

Although the surveillance camera image analysis system according to Embodiment 1 is the one in which the video display control device 4000 assists the user to set up the shooting angle and the object distance of the first surveillance camera 1000, the surveillance camera image analysis system according to the presently disclosed technology is not limited to this embodiment. A surveillance camera image analysis system according to Embodiment 2 includes a configuration in which the shooting angle and the object distance at an image shooting time are determined in a way different from that of Embodiment 1.

In Embodiment 2, the same reference signs as those in Embodiment 1 are used with the exception that a distinction should be made especially between the embodiments. Further, in Embodiment 2, the same explanation as that in Embodiment 1 will be omitted as appropriate.

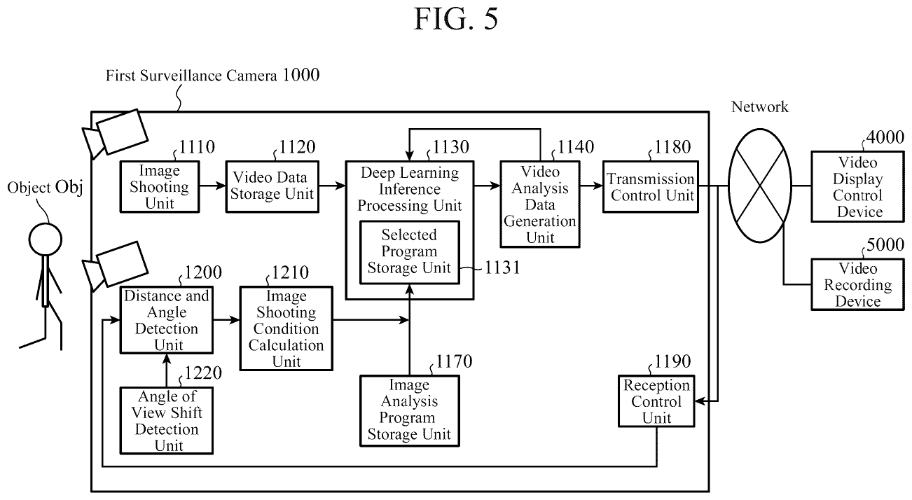

FIG. 5 is a block diagram showing the functional blocks of the surveillance camera image analysis system according to Embodiment 2. As shown in FIG. 5, the surveillance camera image analysis system according to Embodiment 2 differs from that according to Embodiment 1 in the configuration of a first surveillance camera 1000.

As shown in FIG. 5, the first surveillance camera 1000 according to Embodiment 2 includes a distance and angle detection unit 1200 and an angle of view shift detection unit 1220, instead of the distance and angle setting unit 1150.

The distance and angle detection unit 1200 of the first surveillance camera 1000 includes a sensor which detects the shooting angle and the object distance at an image shooting time. In the sensor of the distance and angle detection unit 1200, the orientation of detection is adjusted in such a way as to detect the shooting angle and the object distance which are about a video shot by an image shooting unit 1110.

An image shooting condition calculation unit 1210 according to Embodiment 2 is the same as the image shooting condition calculation unit 1160 according to Embodiment 1, with the exception that information about the shooting angle and the object distance at the image shooting time is inputted not from the distance and angle setting unit 1150, but from the distance and angle detection unit 1200.

As mentioned above, the detection of the shooting angle and the object distance at the image shooting time is performed by the distance and angle detection unit 1200 including the detecting sensor. The distance and angle detection unit 1200 may include a stereoscopic camera or a time of flight camera (TOF camera) in addition to the detecting sensor, thereby implementing at least part of the detection (for example, the detection of the object distance).

When the position or posture of the first surveillance camera 1000 deviates for some reason, and the angle of view of the first surveillance camera 1000 shifts, the angle of view shift detection unit 1220 of the first surveillance camera 1000 detects this shift. The phenomenon in which the angle of view shifts is referred to as the “angle of view shift.”

When detecting there is an angle of view shift, the angle of view shift detection unit 1220 issues a command to detect the shooting angle and the object distance again to the distance and angle detection unit 1200. The distance and angle detection unit 1200 which has received the command from the angle of view shift detection unit 1220 detects the shooting angle and the object distance again.

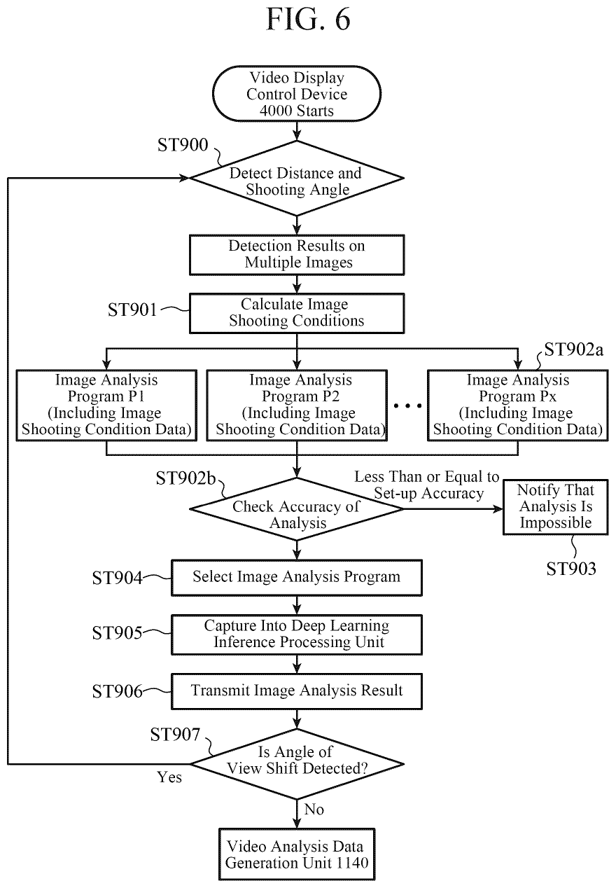

FIG. 6 is a flowchart showing the processing of the surveillance camera image analysis system according to Embodiment 2. As shown in FIG. 6, the processing of the surveillance camera image analysis system according to Embodiment 2 includes a processing step of ST907, in addition to the processing steps of ST900 to ST906 shown in Embodiment 1.

Step ST907 is a process which the angle of view shift detection unit 1220 performs. In step ST907, the angle of view shift detection unit 1220 determines whether or not there is an angle of view shift in the first surveillance camera 1000. When the angle of view shift detection unit 1220, in step ST907, detects an angle of view shift and determines that there is an angle of view shift, no image analysis result is transmitted and the processing steps return to ST900. When the angle of view shift detection unit 1220, in step ST907, does not detect an angle of view shift and determines that there is no angle of view shift, the processing steps proceeds to the next step and an image analysis result is transmitted to a video analysis data generation unit 1140.

As mentioned above, because the surveillance camera image analysis system according to Embodiment 2, particularly the first surveillance camera 1000 includes the distance and angle detection unit 1200, the surveillance camera image analysis system eliminates the necessity for the user to perform an operation of going to the site where the first surveillance camera 1000 is installed, and measuring the shooting angle and the object distance using a measurement tool, in addition to providing the advantageous effect described in Embodiment 1.

Further, because the surveillance camera image analysis system according to Embodiment 2, particularly the first surveillance camera 1000 includes the angle of view shift detection unit 1220, the surveillance camera image analysis system provides the advantageous effect described in Embodiment 1 even when an angle of view shift occurs in the first surveillance camera 1000.

### Embodiment 3

A surveillance camera image analysis system according to Embodiment 3 is an embodiment of taking the advantage of an Internet of Things (IoT) technology.

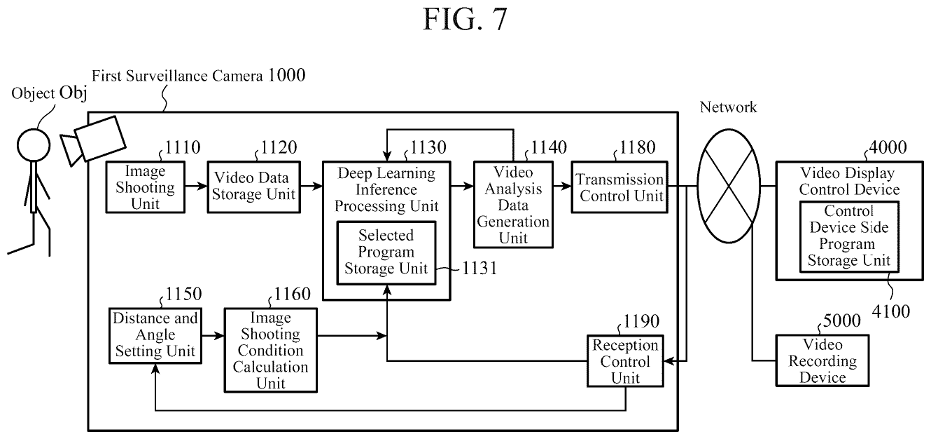

FIG. 7 is a block diagram showing the functional blocks of the surveillance camera image analysis system according to Embodiment 3. As shown in FIG. 7, the surveillance camera image analysis system according to Embodiment 3 has a configuration in which a video display control device 4000 includes a control device side program storage unit 4100, instead of the configuration in which the first surveillance camera 1000 includes the image analysis program storage unit 1170.

The configuration of the surveillance camera image analysis system according to Embodiment 3 is effective especially in the case where image analysis programs P1, P2, . . . , and Px have the same program structure.

A deep learning inference processing unit 1130 according to Embodiment 3, in step ST902a, selects an adjusted parameter corresponding a camera position L1, L2, . . . or Lx which is the nearest to the one at an image shooting time, out of the adjusted parameters corresponding to the image analysis programs P1, P2, . . . , and Px stored in the control device side program storage unit 4100, on the basis of the shooting angle and the object distance at the image shooting time which are determined by a distance and angle setting unit 1150, and image shooting conditions at the image shooting time which are determined by an image shooting condition calculation unit 1160, and downloads the adjusted parameter selected. The downloaded adjusted parameter is stored as appropriate in a selected program storage unit 1131. The deep learning inference processing unit 1130 can reproduce any one of the image analysis programs P1, P2 . . . , and Px by being provided with an image analysis program whose parameter can be changed.

As mentioned above, because the surveillance camera image analysis system according to Embodiment 3 includes the above-mentioned configuration, the surveillance camera image analysis system provides the advantageous effect described in Embodiment 1 while reducing the storage amount of the first surveillance camera 1000.

### Embodiment 4

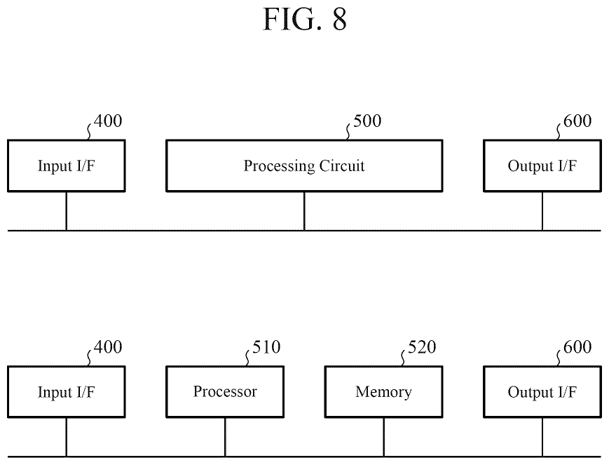

In Embodiment 4, a hardware configuration for implementing the functions of each of the first surveillance cameras 1000 according to Embodiments 1 to 3, particularly the functions of the deep learning inference processing unit 1130 will be described clearly. FIG. 8 is a view showing a hardware configuration for implementing each of the functions of the surveillance camera image analysis system. As shown in FIG. 8, each of the functions of the surveillance camera image analysis system is implemented by a processing circuit mounted in the surveillance camera image analysis system. More specifically, the surveillance camera image analysis system includes a processing circuit for executing each of the functions. The processing circuit may be hardware for exclusive use or a central processing unit (CPU), a central processing device, a processing device, an arithmetic device, a microprocessor, a microcomputer, a processor, or a digital signal processor (DSP) which executes a program stored in a memory.

An upper part of FIG. 8 shows a case in which each of the functions of the surveillance camera image analysis system is executed by hardware. In the case where the processing circuit mounted in the first surveillance camera 1000 is hardware for exclusive use, the processing circuit 500 is, for example, a single circuit, a composite circuit, a programmable processor, a parallel programmable processor, an ASIC, an FPGA, or a combination of these circuits. For example, the functions of the deep learning inference processing unit 1130 may be implemented by the processing circuit 500.

A lower part of FIG. 8 shows a case in which each of the functions of the surveillance camera image analysis system is executed by software. In the case where the processing circuit mounted in the first surveillance camera 1000 is a CPU (a processor 510 in FIG. 8), each of the functions of the first surveillance camera 1000 is implemented by software, firmware, or a combination of software and firmware. Software and firmware are described as programs and the programs are stored in a memory 520. The processing circuit implements the functions of each unit of the first surveillance camera 1000 by reading and executing the programs stored in the memory 520. More specifically, the first surveillance camera 1000 includes the memory 520 for storing the programs in which the processing steps of each unit are executed as a result when the programs are executed by the processing circuit. Further, it can also be said that these programs cause a computer to execute a procedure or a method performed by each unit of the first surveillance camera 1000. Here, the memory 520 may be, for example, a non-volatile or volatile semiconductor memory, such as a RAM, a ROM, a flash memory, an EPROM, or an EEPROM. The memory 520 may be a magnetic disc, a flexible disc, an optical disc, a compact disc, a mini disc, a DVD, or the like. Instead, the memory 520 may be an HDD or an SSD.

A part of the functions of the first surveillance camera 1000 may be implemented by hardware for exclusive use, and another part of the functions may be implemented by software or firmware.

As mentioned above, the processing circuit can implement each of the functions of the first surveillance camera 1000 using hardware, software, firmware, or a combination of hardware, software, and firmware.

### INDUSTRIAL APPLICABILITY

The surveillance camera image analysis system according to the presently disclosed technology can be used for, for example, a monitoring camera system aimed for security purposes, and has industrial applicability.

### REFERENCE SIGNS LIST

400 input interface, 500 processing circuit, 510 processor, 520 memory, 600 output interface, 1000 first surveillance camera, 1110 image shooting unit, 1120 video data storage unit, 1130 deep learning inference processing unit, 1131 selected program storage unit, 1140 video analysis data generation unit, 1150 distance and angle setting unit, 1160 image shooting condition calculation unit, 1170 image analysis program storage unit, 1180 transmission control unit, 1190 reception control unit, 1200 distance and angle detection unit, 1210 image shooting condition calculation unit, 1220 angle of view shift detection unit, 2000 second surveillance camera, 3000 third surveillance camera, 4000 video display control device, and 5000 video recording device.

1. A surveillance camera image analysis system including a first surveillance camera, wherein
the first surveillance camera includes a deep learning inference processing circuitry having artificial intelligence capable of learning, and wherein
the artificial intelligence learns using supervised learning data, and
the supervised learning data is divided in accordance with one or more image shooting angles and one or more object distances.

2. A surveillance camera image analysis system including a first surveillance camera, wherein
the first surveillance camera includes a deep learning inference processing unit circuitry having artificial intelligence which has learned, and wherein
the artificial intelligence which has learned performs at least one of classification, identification, evaluation, tracking, or action prediction, using both a video shot by the first surveillance camera, and information about an image shooting angle and an object distance at an image shooting time.

3. A surveillance camera image analysis system including a first surveillance camera, wherein
the first surveillance camera includes a deep learning inference processing unit circuitry having artificial intelligence which has learned, and wherein
the artificial intelligence which has learned performs semantic segmentation, using both a video shot by the first surveillance camera, and information about an image shooting angle and an object distance at an image shooting time.

4. The surveillance camera image analysis system according to claim 2, wherein the first surveillance camera further includes a distance and angle detection processing circuitry, and
wherein the distance and angle detection processing circuitry detects the image shooting angle and the object distance at the image shooting time.

5. The surveillance camera image analysis system according to claim 3, wherein the first surveillance camera further includes a distance and angle detection processing circuitry, and
wherein the distance and angle detection processing circuitry detects the image shooting angle and the object distance at the image shooting time.

6. The surveillance camera image analysis system according to claim 4, wherein the first surveillance camera further includes an angle of view shift detection processing circuitry, and
wherein the angle of view shift detection processing circuitry detects whether or not there is an angle of view shift in the first surveillance camera, and, when detecting that there is an angle of view shift, issues a command to detect the image shooting angle and the object distance again to the distance and angle detection processing circuitry.

7. The surveillance camera image analysis system according to claim 5, wherein the first surveillance camera further includes an angle of view shift detection processing circuitry, and
wherein the angle of view shift detection processing circuitry detects whether or not there is an angle of view shift in the first surveillance camera, and, when detecting that there is an angle of view shift, issues a command to detect the image shooting angle and the object distance again to the distance and angle detection processing circuitry.
